(19) United States
(12) Patent Application Publication
(10) Pub. No.: US 2004/0105521 A1
(43) Pub. Date: Jun. 3, 2004

(54) Apparatus, method and component for the loading of fuel pellets into a fuel rod

(76) Inventors: Alan Booth, Warrington (GB); Alexander John Mccolville, Warrington (GB)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/343,306

(22) PCT Filed: Jun. 10, 2002
(86) PCT No.: PCT/GB02/02446

(30) Foreign Application Priority Data
Jun. 8, 2001 (GB) 0113983.1

(51) Int. Cl. G21C 19/00

(52) U.S. Cl. 376/272

(57) ABSTRACT

Apparatus for containing nuclear fuel material within a containing environment includes an axis along which a fuel rod to be loaded is introduced, a sealing unit provided between the contaminated environment and a non-contaminated environment, the sealing unit including a first seal, a second seal and an extendible part, the first and second seals being attached to the extendible part, the sealing unit having a first state and a second state, the sealing unit having a greater extent along the axis in the second state than in the first. The first seal may be in the form of a disc having a through aperture with the second seal being a resiliently deformable seal which opens about its middle, the second seal being provided closer to the contaminated environment than the first. A method and component for loading nuclear fuel pellets into a fuel rod are also disclosed.

This invention concerns improvements in and relating to the loading of fuel pellets into a fuel rod, particularly, but not exclusively, mixed oxide (MOX) fuel pellets.

Nuclear fuel pellets need to be loaded into fuel rods as part of the assembly process. This involves introducing a fuel rod into an environment, normally a glove box, containing the fuel pellets, loading the fuel pellets into the fuel rod and removing the fuel rod from the environment. It is desirable to ensure as far as possible that the fuel rod is not contaminated on the outside with fuel pellet material. Such fuel pellet material represents a contamination risk and can impair the quality of the weld used to seal the loaded fuel rod. A variety of cleaning operations may be used to remove any fuel pellet material accumulating in this area, however, none to date are entirely satisfactory. Furthermore, many of the prior art techniques have been developed in relation to the loading of uranium dioxide fuel pellets and as a consequence are not suitable for use with mixed oxide fuel pellets where the radiological dose from the fuel is much higher.

The present invention has amongst its aims the provision of apparatus and a method for loading fuel pellets into a fuel rod which gives lower levels of contamination of the outside of the fuel rod with fuel pellet material. The present invention also has amongst its aims the provision of apparatus and a method for loading fuel pellets into a fuel rod which maintains containment of nuclear material prior to and/or during and/or after loading.

According to a first aspect of the invention we provide apparatus for containing nuclear fuel material within a contaminated environment during the loading of nuclear fuel pellets into a fuel rod, the apparatus including an axis along which a fuel rod to be loaded is introduced, a sealing unit provided between the contaminated environment and a non-contaminated environment, the sealing unit including a first seal, a second seal and an extendable part, the first and second seals being attached to the extendable part, the sealing unit have a first state and a second state, the sealing unit having a greater extent along the axis in the second state than in the first.

According to a second aspect of the invention we provide a method of loading nuclear fuel pellets into a fuel rod, the method including introducing the fuel rod to a nuclear fuel pellet loading position along an axis, loading one or more nuclear fuel pellets into the fuel rod and removing the fuel rod from the nuclear fuel pellet loading position, a sealing unit being provided between a contaminated environment which includes the nuclear fuel pellets to be loaded into the fuel rod and a non-contaminated environment, the sealing unit including a first seal, a second seal and an extendable part, the first and second seals being attached to the extendable part, the sealing unit having a first state and a second state, the sealing unit being in the second state for the loading of the nuclear fuel pellets into the fuel rod and moving towards the first state during at least a part of the transition of the fuel rod from the nuclear fuel pellet loading position to the fuel rod having been removed, the sealing unit having a greater extent along the axis in the second state than in the first.

The first and/or second aspects of the invention may particularly include the first seal being in the form of a disc and having a through aperture, the second seal being a resiliently deformable seal which opens about its middle when deformed, the second seal being provided closer to the contaminated environment than the first seal and/or the first seal being in the form of a disc and having a through aperture, the fuel rod extending at least into the first seal in the nuclear fuel pellet loading position, the second seal being a resiliently deformable seal which opens about its middle, the second seal being deformed with the fuel rod in the nuclear fuel pellet loading position, the second seal being provided closer to the contaminated environment than the first seal.

According to a third aspect of the invention we provide apparatus for containing nuclear fuel material within a contaminated environment during the loading of nuclear fuel pellets into a fuel rod, the apparatus including a sealing unit provided between the contaminated environment and a non-contaminated environment, the sealing unit including a first seal and a second seal, the first seal being in the form of a disc and having a through aperture, the second seal being a resiliently deformable seal which opens about its middle when deformed, the second seal being provided closer to the contaminated environment than the first seal.

According to a fourth aspect of the invention we provide a method of loading nuclear fuel pellets into a fuel rod, the method including introducing the fuel rod to a nuclear fuel pellet loading position, loading one or more nuclear fuel pellets into the fuel rod and removing the fuel rod from the nuclear fuel pellet loading position, a sealing unit being provided between a contaminated environment which includes the nuclear fuel pellets to be loaded into the fuel rod and a non-contaminated environment, the sealing unit including a first seal and a second seal, the first seal being in the form of a disc and having a through aperture, the fuel rod extending at least into the first seal in the nuclear fuel pellet loading position, the second seal being a resiliently deformable seal which opens about its middle, the second seal being deformed with the fuel rod in the nuclear fuel pellet loading position, the second seal being provided closer to the contaminated environment than the first seal.

The third and/or fourth aspects of the invention may particularly include the apparatus including an axis along which a fuel rod to be loaded is introduced, the sealing unit including an extendable part, the first and second seals being attached to the extendable part, the sealing unit have a first state and a second state, the sealing unit having a greater extent along the axis in the second state than in the first and/or introducing the fuel rod to a nuclear fuel pellet loading position along an axis, the sealing unit including an extendable part, the first and second seals being attached to the extendable part, the sealing unit having a first state and a second state, the sealing unit being in the second state for the loading of the nuclear fuel pellets into the fuel rod and moving towards the first state during at least a part of the transition of the fuel rod from the nuclear fuel pellet loading position to the fuel rod having been removed, the sealing unit having a greater extent along the axis in the second state than in the first.

The first and/or second and/or third and/or fourth aspects of the invention may include any of the features, options or possibilities set out elsewhere in this document including the following and the features, options or possibilities set out elsewhere in this document including the fifth and/or sixth aspects of the invention, particularly as they relate to the component provided on the fuel rod during loading.

Preferably the nuclear fuel material is contained to stop its physical transfer from the contaminated environment into the non-contaminated environment, ideally from a contaminated glove box to a non-contaminated glove box.

Preferably the axis corresponds with the axis of the fuel rod during its introduction and/or loading and/or removal. Preferably a tube or shroud is provided about at least a part of the axis and ideally has a common axis therewith. Preferably the tube extends into the contaminated environment, at least relative to the surrounding barrier which separates the contaminated environment from the non-contaminated environment.

Preferably the sealing unit is mounted on one end of the tube, ideally the end of the tube connecting to the contaminated environment. Preferably the sealing is removable. Preferably the sealing unit has an axis corresponding to the axis of the apparatus. Preferably the sealing unit is symmetrical about its axis.

Preferably the first seal is in the form of a disc having a through aperture. Preferably the through aperture is of circular cross-section, ideally with an axis corresponding to the axis of the sealing unit and/or the axis of introduction and/or the axis of the fuel rod. Preferably the diameter of the aperture is no greater than the diameter of the fuel rod. Preferably at least the part of the first seal extending around the aperture is resiliently deformable. Preferably the first seal aperture is extended in size during the transition from first to second state. Preferably the first seal aperture decreases in size during the transition from second to first state. Preferably the first seal has one or more further through apertures. Preferably the further apertures are provided around the periphery of the first seal. Preferably the further apertures provide a flow route for a purge gas in the second state and/or with the fuel rod in the nuclear fuel pellet loading position. Preferably the aperture and/or the one or more further apertures provide a flow route for a purge gas in the first state and/or during the introduction and/or removal of a fuel rod.

Preferably the second seal is a resiliently deformable seal which opens about its middle when deformed. Preferably the opening is of circular cross-section, ideally with an axis corresponding to the axis of the sealing unit and/or the axis of introduction and/or the axis of the fuel rod. Preferably the diameter of the aperture is less than the diameter of the fuel rod in the first state. Preferably the aperture is closed in the first state. Preferably at least the part of the second seal extending around the aperture is resiliently deformable. Preferably the second seal is a lip seal. Preferably the part of the second seal defining the aperture extends further towards the contaminated environment that the part attached to the extendable part. Preferably the second seal aperture is extended in size during the transition from first to second state and/or introduction of the fuel rod to the nuclear fuel pellet loading position. Preferably the second seal aperture extends from a first size to a second size during the transition from first to second state and/or introduction of the fuel rod to the nuclear fuel pellet loading position. Preferably the second seal aperture decreases in size during the transition from second to first state and/or introduction of the fuel rod to the nuclear fuel pellet loading position. Preferably the second seal deceases from a second size to an intermediate size and then a first size during the transition from second state to first state and/or introduction of the fuel rod to the nuclear fuel pellet loading position.

Preferably the extendable part includes a portion which is bent to have a reduced extent along the axis in the first state. Preferably the extendable part includes a portion which straightens to give an increased extent along the axis in the second state. The extendable part may include a cylindrical portion which barrels, ideally outward, in the first state. The extendable part may include a bellows. The extendable part may stretch during the transition from first to second state. Preferably the extendable part includes a through aperture. Preferably the through aperture is of greater diameter than a fuel rod in the first and/or second states and/or the transition between the two in one or both directions. Preferably the extendable part is connected to the tube.

Preferably the first seal is attached to the extendable part at one end thereof, ideally the end removed from the tube at the same end as the first seal and/or at the end closer to the contaminated environment.

Preferably the second seal is attached to the extendable part at one end thereof, ideally the end removed from the tube and/or at the same end as the second seal and/or at the end closer to the contaminated environment.

Preferably the sealing unit is in the first state prior to the introduction of the fuel rod. Preferably the sealing unit begins the transition from the first to the second state when the fuel rod, or more preferably a component provided thereon, abuts the first seal. Preferably the sealing unit reaches the second state before the fuel rod passes through the first seal and ideally before a component provided on the fuel rod passes through the first seal. Preferably the fuel rod passes into the first seal in the second state. Ideally a component provided on the fuel rod passes through the first seal in the second state. Preferably a component provided on the fuel rod abuts the second seal in the second state. Preferably a component provided on the fuel rod, at least in part, passes through the second seal in the second state. Preferably the open end of the fuel rod remains between the first and second seals in the second state. Preferably a flow of gas passes between the second seal and the component in the second state and particularly in the nuclear fuel pellet loading position.

Preferably a component provided on the fuel rod is rotated during the transition from second to first state and/or separates from the fuel rod during the transition from second to first state. Preferably the fuel rod at least extends into the first seal whilst the component extends into the second seal. Preferably the second seal moves back over the component during the transition from second to first state. Preferably the second seal is withdrawn from the component by the completion of the transition from the second state to the first state. Preferably the fuel rod is withdrawn from the first seal in the first state. Preferably the component is discarded, ideally by dropping, in the :first state.

The nuclear fuel pellets may particularly be mixed oxide containing and/or contain reprocessed uranium.

The fuel rod is preferably sealed at one end and open at the other end, particularly when the component is introduced to the fuel rod. The fuel rod is generally of circular cross-section.

Preferably the fuel rod, ideally provided with the component, is introduced to the nuclear fuel pellet loading position automatically. The fuel rod may be introduced supported on one or more rotatable supports, such as rollers. Preferably the fuel road, ideally provided with the component, is introduced to a nuclear fuel pellet loading position through a tube. Preferably the tube is of circular cross-section. Preferably the tube extends between a part of the non-contaminated environment and a part of the contaminated environment. Preferably the tube extends between a first and a second glove box. Preferably a sealing unit is provided on one end of the tube, ideally the end of the tube adjoining the contaminated environment.

Preferably a purge gas is introduced into the tube. The gas may be helium. Preferably the purge gas is introduced before the fuel rod, and ideally component, are introduced to the nuclear fuel pellet loading position and/or during introduction and/or during loading and/or during removal of the component from the fuel rod and/or during removal of the fuel rod from the nuclear fuel pellet loading position and/or between the removal of one fuel rod and the introduction of the next fuel rod to be loaded.

Preferably the component abuts a nuclear fuel pellet loading guide in the nuclear fuel pellet loading position. Preferably the component is received within a partial recess in the loading guide. The partial recess is preferably absent from under the component. The loading guide is preferably mounted in a fixed position within the contaminated environment. The load guide preferably has a through bore of greater internal diameter than the external diameter of the nuclear fuel pellets to be loaded. The through bore may taper inwards towards the component abutting side. Preferably the through bore on the component abutting side has a diameter less than the diameter of the component at that location.

Preferably the nuclear fuel pellets are loaded into the fuel rod through the loading guide and the component.

According to a fifth aspect of the invention we provide a component for use during the loading of nuclear fuel pellets into a fuel rod, the component including a first cylindrical portion and a second cylindrical portion, the external diameter of the second portion being less than the external diameter of the first portion, the external diameter of the second portion being less than the internal diameter of the fuel rod with which the component is to be used, the external diameter of the first portion corresponding to the external diameter of the fuel rod with which the component is to be used, the first and second portions having a common axis, which axis corresponds with the axis of the fuel rod with which the component is to be used, the component having a through bore centred on the axis of the component, the internal diameter of the through bore being less than the external diameter of the nuclear fuel pellets loaded through the component into the fuel rod in use.

According to a sixth aspect of the invention we provide a method of loading nuclear fuel pellets into a fuel rod the method including inserting a component into one end of the fuel rod, introducing the fuel rod and the component into a nuclear fuel pellet loading position, loading one or more nuclear fuel pellets into the fuel rod through the component and removing the component from the fuel rod, the component including a first cylindrical portion and a second cylindrical portion, the external diameter of the second portion being less than the external diameter of the first portion, the external diameter of the second portion being less than the internal diameter of the fuel rod, the external diameter of the first portion corresponding to the external diameter of the fuel rod, the component having a through bore, the internal diameter of the through bore being less than the external diameter of the nuclear fuel pellets loaded through the component into the fuel rod.

The first and second portions preferably have a common axis, which axis corresponds with the axis of the fuel rod with which the component is to be used. The component preferably has a through bore centred on the axis of the component.

The fifth and/or sixth aspects of the invention may include one or more of the features, options or possibilities set out elsewhere in this document, including the following.

The nuclear fuel pellets may particularly be mixed oxide containing and/or contain reprocessed uranium.

The fuel rod is preferably sealed at one end and open at the other end, particularly when the component is introduced to the fuel rod. The fuel rod is generally of circular cross-section.

Preferably the component is inserted into the fuel rod manually. Preferably the component is inserted into the fuel rod in a clean environment and/or nuclear fuel free environment Preferably the component is provided with one or more external markings. Preferably the one or more external markings differ from any markings on the fuel rod. The component may be coloured on its external surface or a part thereof. The colouration may be caused by a heat treatment.

Preferably the fuel rod provided with the component is introduced to the nuclear fuel pellet loading position automatically. The fuel rod may be introduced supported on one or more rotatable supports, such as rollers. Preferably the fuel road provided with the component is introduced to a nuclear fuel pellet loading position through a tube. Preferably the tube is of circular cross-section. Preferably the tube extends between a part of a non-contaminated environment and a part of a contaminated environment. Preferably the tube extends between a first and a second glove box. Preferably a sealing unit is provided on one end of the tube, ideally the end of the tube adjoining the contaminated environment. Preferably the sealing unit is provided according to the first and/or second aspect of the invention, including any of the further options, possibilities or features set out in the rest of this document.

Preferably a purge gas is introduced into the tube. The gas may be helium. Preferably the purge gas is introduced before the fuel rod and component are introduced to the nuclear fuel pellet loading position and/or during introduction and/or during loading and/or during removal of the component for the fuel rod and/or during removal of the fuel rod from the nuclear fuel pellet loading position and/or between the removal of one fuel rod and the introduction of the next fuel rod to be loaded.

Preferably the component abuts a nuclear fuel pellet loading guide in the nuclear fuel pellet loading position. Preferably the component is received within a partial recess in the loading guide. The partial recess is preferably absent from under the component. The loading guide is preferably mounted in a fixed position within the contaminated environment. The load guide preferably has a through bore of greater internal diameter than the external diameter of the nuclear fuel pellets to be loaded. The through bore may taper inwards towards the component abutting side. Preferably the through bore on the component abutting side has a diameter less than the diameter of the component at that location.

Preferably the nuclear fuel pellets are loaded into the fuel rod through the loading guide and the component. Preferably the nuclear fuel pellets first contact the inside of the fuel rod at least 9.8 mm inside the fuel rod and more preferably at least 10.2 mm inside the fuel rod.

Preferably the component is held in position, in an axial sense, when it is removed from the fuel rod. Preferably the component is removed from the fuel rod by retracting the fuel rod relative to the nuclear fuel pellet loading position. Preferably the fuel rod is retracted into the tube. Preferably the fuel rod is retracted away from the contaminated environment. Preferably the component is rotated about its axis prior to the retraction of the fuel rod and/or whilst the fuel rod is retracted. The component is preferably held in position by a releasable clamp. The clamp may be hydraulically operated. The clamp may include one or more rotatable clamping surfaces. A motor may be provided as a part of the clamp structure to effect the rotation.

Preferably the clamp is provided in an open position prior to the introduction of the fuel rod to the nuclear fuel pellet loading position and/or during introduction of the fuel rod. Preferably the clamp is provided in the clamped position upon the fuel rod reaching the nuclear fuel pellet loading position and/or during the loading of the fuel pellets and/or during removal of the fuel rod. Preferably the clamp only contacts the component.

Preferably the component is moved to a discarded location after removal from the fuel rod. The component may be moved by dropping the component from the clamp. Preferably the component is dropped into a moveable container. The moveable container may accommodate one or more used components. The components may be removed from the contaminated environment after use, as contaminated material.

The component may have a first cylindrical portion whose external diameter is between +0.05 mm and −0.05 mm the external diameter of the fuel rod. The component may have a second portion whose external diameter is between +0.007 mm and −0.007 the internal diameter of the fuel rod. The through bore of the component may be at least 0.05 mm greater than the external diameter of the nuclear fuel pellets. The second component may be between 29.80 mm and 30.20 mm long. The first portion may be between 19.75 mm and 20.25 mm long.

The first and second portions may be formed from separate parts. Preferably the first portion is a cylinder into which a part of the cylinder forming the second portion is inserted. The second portion may be swaged within the first portion to form the component. The first portion may have a recess and/or increased diameter section to accommodate the thickness of the second portion to be swaged.

Various embodiments of the invention will now be described, by way of example only, and with reference to the accompanying drawings in which:-

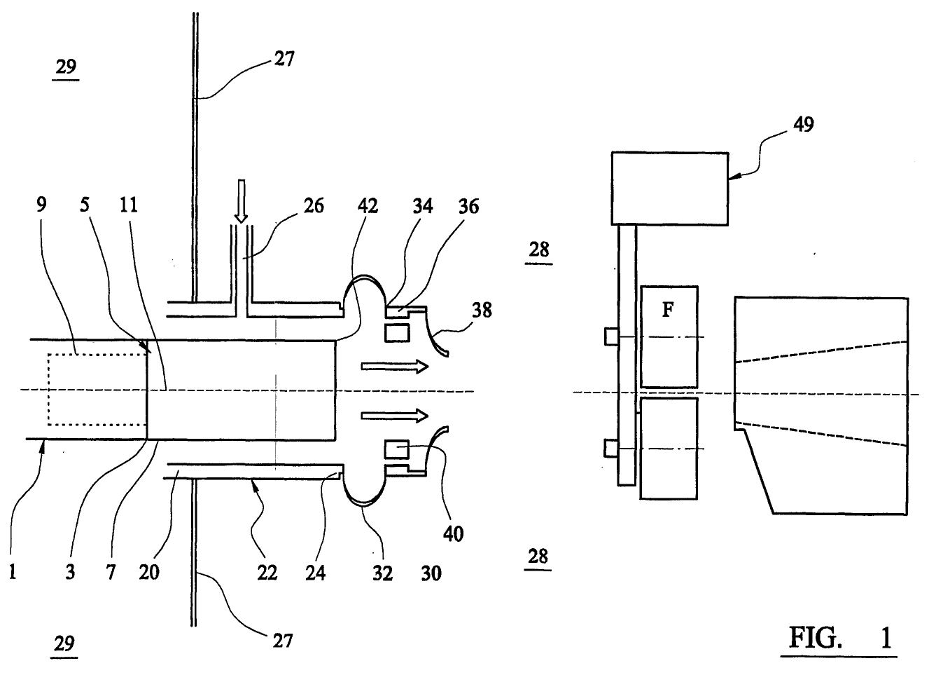

FIG. 1 schematically illustrates a fuel rod being introduced into the loading position;

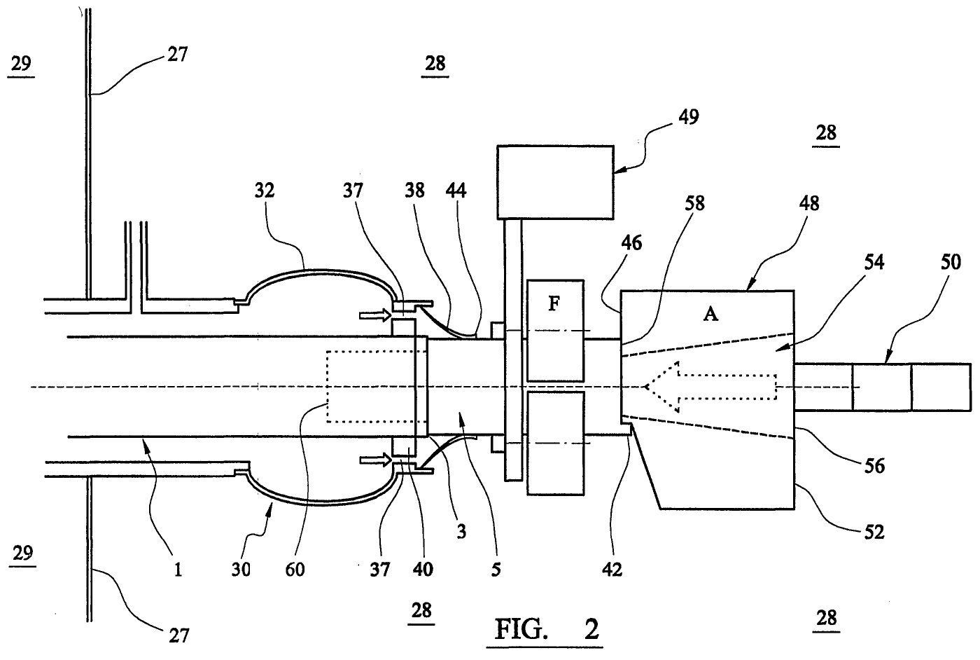

FIG. 2 schematically illustrates the fuel rod during loading;

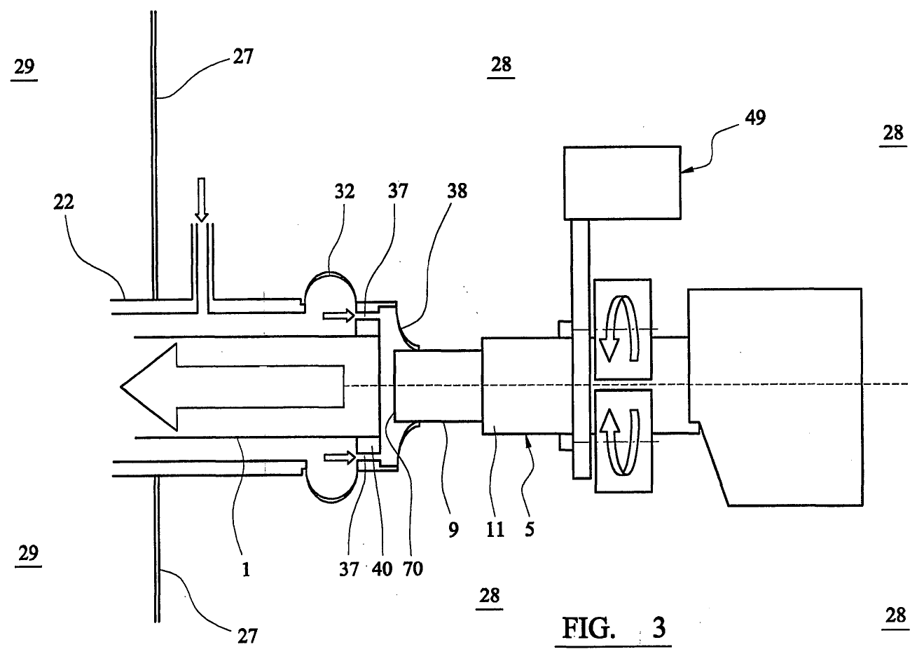

FIG. 3 schematically illustrates the fuel rod during an initial stage of removal from the loading position; and,

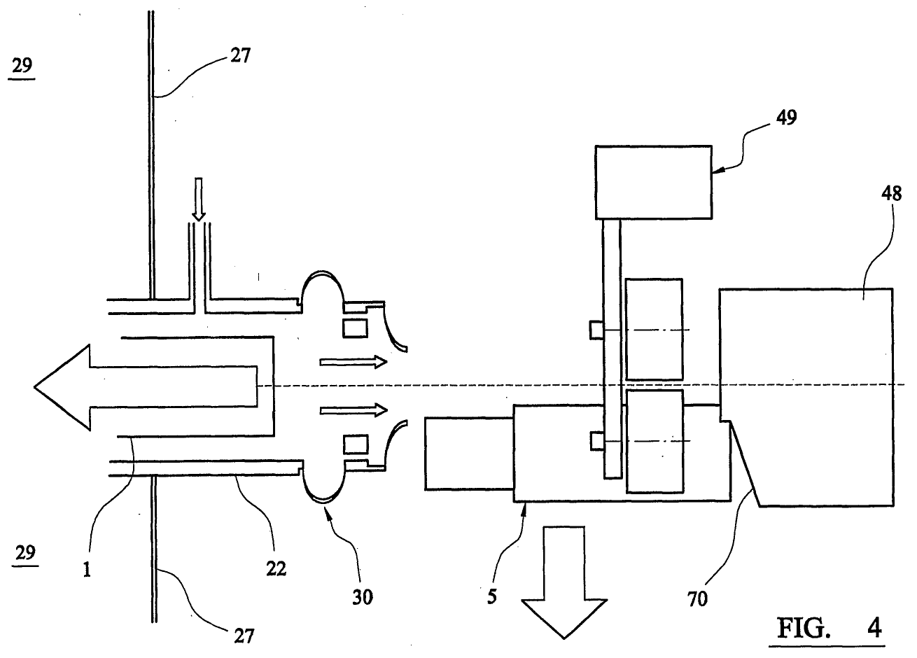

FIG. 4 schematically illustrates the fuel rod during a later stage of removal from the loading position.

In the technique of the invention the nuclear fuel rods are assembled in a clean environment; then introduced into a contaminated environment, provided with fuel pellets, according to the technique described in more detail below; and then removed for further processing, with the fuel pellets being contained by the fuel rod.

Prior to introduction into the contaminated environment a fuel rod 1 is provided at the loading end 3 with a sleeve 5 in the form of a throatbush. The sleeve 5 has a first diameter portion 7 of corresponding external diameter to the external diameter of the fuel rod 1 and a second reduced external diameter portion 9 whose external diameter corresponds to the internal diameter of the fuel rod 1 so as to provide a snug fit. A through bore 11 which is larger than the external diameter of the fuel pellets to be loaded, is provided in the sleeve 5. The sleeve 5 is generally formed of very thin metal and is provided with an external colouring different from the external colouring of the fuel rod 1 to assist in confining its presence. The sleeve 5 entirely protects the loading end 3 of the fuel rod 1 against contamination or the presence of any material which could detract from the quality of subsequent welds.

With the sleeve 5 snugly secured in the end 3 of the fuel rod 1, the fuel rod 1 is inserted into the contaminated environment, FIG. 1. The fuel rod 1 is inserted into one end 20 of a stainless steel tube 22 which acts as a shroud. The other end 24 of the tube 22 is provided with a sealing unit 30, described in more detail below. A helium supply is connected to the tube 22 by pipe 26 and acts to purge the tube 22 in the direction of the other end 24 which leads to the contaminated environment 28 which contains the fuel pellets to be loaded. The tube 22 passes through barrier 27 which separates the “contaminated” environment 28 from the “clean” environment 29.

The sealing unit 30 includes a flexible part 32 in the form of bellows which at one end snugly engages the tube 22 and at the other end 34 is connected to a link part 36. The link part 36 is in the form of a disc which includes a number of apertures 37, connects to lip seal 38, and provides a collar seal 40.

As the fuel rod 1 and sleeve 5 advance the leading edge 42 of the sleeve 5 engages with the collar seal 40. The further advance of the fuel rod 1 and sleeve 5 pushes the collar seal 40 and lip seal 38 forward further into the contaminated environment 28 and in doing so flexes the flexible part 32 of the sealing unit 38 in a manner which extends a distance between its junction with the end of the tube 22 and the linking part 36. When the flexible part 32 reaches its maximum intended extended state, the flexible part 32 offers sufficient resistence to further extension that the leading edge 42 of the sleeve 5 passes into and through the collar seal 40 whose internal diameter snugly engages with the outside diameter of the sleeve 5. Continued advancement of the fuel rod 1 and sleeve 5 causes the leading edge 42 of the sleeve 5 to abut the lip seal 38 and displace it so as to stretch and open up the lip seal 38. The sleeve 5 then advances further, projecting into the contaminated environment 28, from which point the part of its external surface projecting beyond the engagement between the lip 44 of the lip seal 38 and the sleeve 5 is assumed to be contaminated too. Further advancement brings the leading edge, loading end 3, of the fuel rod 1 into and through the collar seal 40. As the loading position is reached, FIG. 2, the leading edge 42 of the sleeve 5 passes through the open clamp 49 and engages with one side 46 of a permanent loading guide 48 mounted in the contaminated environment 28. Once in this position the sleeve 5 is gripped by a clamp 49 provided within the contaminated environment 28. In the loading position all of the fuel rod 1 is within the sealing unit 30 and as a consequence is not exposed to any material which could contaminate its external surface and/or detract from the quality of subsequent welding.

Once in position, FIG. 2, the stack of fuel pellets 50 which have been prepared can be advanced towards the other side 52 of the permanent loading guide 48. The loading guide 48 is provided with a through bore 54 which tapers from a larger diameter 56 at the other side 52 to a reduced diameter 58 at the one side 46. The larger diameter 56 and reduced diameter 58 are both of greater diameter than the external diameter of the fuel pellets 50. The loading guide 48 guides the pellets 50 into the sleeve 5 and then into the fuel rod 1. The sleeve 5 also has a slight taper between its end 42 and the end provided inside the fuel rod. Throughout the sleeve 5 has an internal diameter greater than the external diameter of the fuel pellets 50. The reduced diameter portion 9 of the sleeve 5 is sufficiently thick to be mechanically strong enough to withstand insertion into the fuel rod 1 and withdraw therefrom after use, but sufficiently thin that it sits within the tolerance provided between the outside of the fuel pellets 50 and the inside of the fuel rod 1 without interfering with movement of the pellets.

The provision of the sleeve 5 and the portion 9 thereof which extends into the fuel rods means that contact between the pellets and the inside of the fuel rod 1 does not occur until location 60 by which time the fuel pellets 50 are a significant distance within the fuel rod 1. The end portion of the inside of the fuel rod 1 is thus kept clean of fuel pellet material.

During loading, the helium purge continues with the gas flowing though the apertures 37 in the link part 36 and collar seal 40, before exiting the sealing unit 30 between the sleeve 5 and lip seal 38; this assists in stopping material building up on the outside of the sleeve 5 particularly at the junction between the lip seal 38 and the sleeve 5 by blowing it away and also prevents material passing through the lip seal 38 into the sealing unit 30.

Once loaded the fuel rod 1 can be withdrawn and fed to subsequent process steps at other locations. As an initial step in the withdrawal process, FIG 3, the sleeve 5 is held firmly in position by the clamp 49 and rotated (using a powered roller on one arm of the clamp and two unpowered rollers on the other arm) relative to the fuel rod 1 which is simultaneously withdrawn away from the contaminated environment 28. The rotation is important in ensuring that as much as possible of any pellet material which has accumulated on the end 70 of the inside of the sleeve 5 is left inside the fuel rod 1. As this process continues the fuel rod 1 is pulled back into the tube 22 and draws with it the collar seal 40. This causes the extent of the flexible part 32 to decrease and pulls with it the lip seal 38. As retraction continues the contact between the lip seal 38 and the sleeve 5 is drawn back off the larger diameter portion 11 and on to the reduced diameter portion 9. The lip seal 38 immediately assumes a reduced diameter upon leaving the larger diameter portion 11 of the sleeve 5, thereby maintaining a seal throughout. When the flexible part 32 of the sealing unit 30 reaches its reduced extent, further movement of the collar 40 towards the environment 29 is resisted, and the fuel rod 1 is pulled back through the collar seal 40. The lip seal 38 is pulled back off the sleeve 5, but by the time it leaves it the fuel rod 1 is back in the tube 22 and fully protected against contamination of its outside surface as a result. The lip seal 38 closes to a small a hole as possible in this configuration and helium continues to purge through it preventing contamination of the inside of the sealing unit 30 by material in the contaminated environment 28.

With the sealing unit 30 retracted there is sufficient space between the end of the lip seal 38 and the permanent loading guide 48 for the pneumatic clamp 49 to be released and the sleeve 5 to drop into the contaminated environment 28. A cutaway portion 70 is provided in the bottom of the permanent loading guide 48 to facilitate this drop. The use of a permanent loading guide 48 means that initial loose contamination on the pellets 50 tends to accumulate on this component rather than on the lead edge of the sleeve 5. As a consequence the contamination level of the sleeves 5 is kept as low as possible thereby easing the disposal of the sleeves as contaminated waste. The discarded sleeve 5 falls into a pot, not shown, which can be periodically removed from the contaminated environment 28 according to contaminated material processes. The helium purge continues throughout this time to ensure that contaminating material does not enter the sealing unit 30. The constricted end of the lip seal 38 also assists in this.

The process is repeated for fuel rods 1, one after another, using a fresh sleeve 5 in each case.

Different sleeves 5 diameters and lengths may be used for different fuel rod diameters and/or types.

A preferred construction for the sleeve 5 involves a cylinder forming the larger diameter portion 11 with a foil tube forming the reduced diameter portion 9, the foil tube being inserted into the cylinder and then swayed outwards into an increased internal diameter part of the portion 11.

1. Apparatus for containing nuclear fuel material within a contaminated environment during the loading of nuclear fuel pellets into a fuel rod, the apparatus including an axis along which a fuel rod to be loaded is introduced, a sealing unit provided between the contaminated environment and a non-contaminated environment, the sealing unit including a first seal, a second seal and an extendable part, the first and second seals being attached to the extendable part, the sealing unit have a first state and a second state, the sealing unit having a greater extent along the axis in the second state than in the first.

2. Apparatus according to claim 1 which includes the first seal being in the form of a disc and having a through aperture, the second seal being a resiliently deformable seal which opens about its middle when deformed, the second seal being provided closer to the contaminated environment than the first seal.

3. Apparatus for containing nuclear fuel material within a contaminated environment during the loading of nuclear fuel pellets into a fuel rod, the apparatus including a sealing unit provided between the contaminated environment and a non-contaminated environment, the sealing unit including a first seal and a second seal, the first seal being in the form of a disc and having a through aperture, the second seal being a resiliently deformable seal which opens about its middle when deformed, the second seal being provided closer to the contaminated environment than the first seal.

4. Apparatus according to claim 3 which includes the apparatus including an axis along which a fuel rod to be loaded is introduced, the sealing unit including an extendable part, the first and second seals being attached to the extendable part, the sealing unit have a first state and a second state, the sealing unit having a greater extent along the axis in the second state than in the first.

5. Apparatus according to any preceding claim in which the fuel rod is introduced to a nuclear fuel pellet loading position along an axis, the sealing unit including an extendable part, the first and second seals being attached to the extendable part, the sealing unit having a first state and a second state, the sealing unit being in the second state for the loading of the nuclear fuel pellets into the fuel rod and moving towards the first state during at least a part of the transition of the fuel rod from the nuclear fuel pellet loading position to the fuel rod having been removed, the sealing unit having a greater extent along the axis in the second state than in the first.

6. Apparatus according to any preceding claim in which the first seal is in the form of a disc having a through aperture.

7. Apparatus according to any preceding claim in which the first seal aperture is extended in size during the transition from first to second state and/or the first seal aperture decreases in size during the transition from second to first state.

8. Apparatus according to any preceding claim in which the second seal is a resiliently deformable seal which opens about its middle when deformed, the diameter of the aperture is less than the diameter of the fuel rod in the first state.

9. Apparatus according to any preceding claim in which the second seal aperture is extended in size during the transition from first to second state and/or introduction of the fuel rod to the nuclear fuel pellet loading position and/or decreases in size during the transition from second to first state and/or introduction of the fuel rod to the nuclear fuel pellet loading position.

10. Apparatus according to any preceding claim in which the extendable part includes a portion which is bent to have a reduced extent along the axis in the first state and the extendable part includes a portion which straightens to give an increased extent along the axis in the second state.

11. A method of loading nuclear fuel pellets into a fuel rod, the method including introducing the fuel rod to a nuclear fuel pellet loading position along an axis, loading one or more nuclear fuel pellets into the fuel rod and removing the fuel rod from the nuclear fuel pellet loading position, a sealing unit being provided between a contaminated environment which includes the nuclear fuel pellets to be loaded into the fuel rod and a non-contaminated environment, the sealing unit including a first seal, a second seal and an extendable part, the first and second seals being attached to the extendable part, the sealing unit having a first state and a second state, the sealing unit being in the second state for the loading of the nuclear fuel pellets into the fuel rod and moving towards the first state during at least a part of the transition of the fuel rod from the nuclear fuel pellet loading position to the fuel rod having been removed, the sealing unit having a greater extent along the axis in the second state than in the first.

12. A method of loading nuclear fuel pellets into a fuel rod, the method including introducing the fuel rod to a nuclear fuel pellet loading position, loading one or more nuclear fuel pellets into the fuel rod and removing the fuel rod from the nuclear fuel pellet loading position, a sealing unit being provided between a contaminated environment which includes the nuclear fuel pellets to be loaded into the fuel rod and a non-contaminated environment, the sealing unit including a first seal and a second seal, the first seal being in the form of a disc and having a through aperture, the fuel rod extending at least into the first seal in the nuclear fuel pellet loading position, the second seal being a resiliently deformable seal which opens about its middle, the second seal being deformed with the fuel rod in the nuclear fuel pellet loading position, the second seal being provided closer to the contaminated environment than the first seal.

13. A method according to claim 11 or 12 in which the sealing unit is in the first state prior to the introduction of the fuel rod, the sealing unit begins the transition from the first to the second state when a component provided on the fuel rod abuts the first seal, the sealing unit reaches the second state before a component provided on the fuel rod passes through the first seal.

14. A method according to claim 13 in which the fuel rod passes into the first seal in the second state, a component provided on the fuel rod passes through the first seal in the second state and a component provided on the fuel rod abuts the second seal in the second state.

15. A method according to claim 13 or claim 14 in which a component provided on the fuel rod, at least in part, passes through the second seal in the second state.

16. A method according to any of claims 11 to 15 in which the fuel rod at least extends into the first seal whilst a component provided thereon extends into the second seal.

17. A component for use during the loading of nuclear fuel pellets into a fuel rod, the component including a first cylindrical portion and a second cylindrical portion, the external diameter of the second portion being less than the external diameter of the first portion, the external diameter of the second portion being less than the internal diameter of the fuel rod with which the component is to be used, the external diameter of the first portion corresponding to the external diameter of the fuel rod with which the component is to be used, the first and second portions having a common axis, which axis corresponds with the axis of the fuel rod with which the component is to be used, the component having a through bore centred on the axis of the component, the internal diameter of the through bore being less than the external diameter of the nuclear fuel pellets loaded through the component into the fuel rod in use.

18. A component according to claim 17 in which the component has a first cylindrical portion whose external diameter is between +0.05 mm and −0.05 mm the external diameter of the fuel rod and the component has a second portion whose external diameter is between +0.007 mm and −0.007 the internal diameter of the fuel rod.

19. A component according to claim 17 or claim 18 in which the through bore of the component is at least 0.05 mm greater than the external diameter of the nuclear fuel pellets.

20. A component according to any of claims 17 to 19 in which the first and second portions are formed from separate parts, the first portion is a cylinder into which a part of the cylinder forming the second portion is inserted and the second portion is swaged within the first portion to form the component.

21. A method of loading nuclear fuel pellets into a fuel rod the method including inserting a component into one end of the fuel rod, introducing the fuel rod and the component into a nuclear fuel pellet loading position, loading one or more nuclear fuel pellets into the fuel rod through the component and removing the component from the fuel rod, the component including a first cylindrical portion and a second cylindrical portion, the external diameter of the second portion being less than the external diameter of the first portion, the external diameter of the second portion being less than the internal diameter of the fuel rod, the external diameter of the first portion corresponding to the external diameter of the fuel rod, the component having a through bore, the internal diameter of the through bore being less than the external diameter of the nuclear fuel pellets loaded through the component into the fuel rod.

22. A method according to claim 21 in which the fuel rod provided with the component is introduced to the nuclear fuel pellet loading position automatically and the fuel rod is introduced supported on one or more rotatable supports.

23. A method according to claim 21 or claim 22 in which a purge gas is introduced into the tube before the fuel rod and component are introduced to the nuclear fuel pellet loading position and/or during introduction and/or during loading and/or during removal of the component for the fuel rod and/or during removal of the fuel rod from the nuclear fuel pellet loading position and/or between the removal of one fuel rod and the introduction of the next fuel rod to be loaded.

24. A method according to any of claims 21 to 23 in which the component abuts a nuclear fuel pellet loading guide in the nuclear fuel pellet being received within a partial recess in the loading guide.

25. A method according to any of claims 21 to 24 in which the nuclear fuel pellets are loaded into the fuel rod through the loading guide and the component and the nuclear fuel pellets first contact the inside of the fuel rod at least 9.8 mm inside the fuel rod.

26. A method according to any of claims 21 to 25 in which the component is removed from the fuel rod by retracting the fuel rod relative to the nuclear fuel pellet loading position, the component being held in position by a releasable clamp.
